(19) United States
(12) Patent Application Publication
(10) Pub. No.: US 2009/0055684 A1
(43) Pub. Date: Feb. 26, 2009

(54) METHOD AND APPARATUS FOR EFFICIENT PROBLEM RESOLUTION VIA INCREMENTALLY CONSTRUCTED CAUSALITY MODEL BASED ON HISTORY DATA

(76) Inventors: Hani T. Jamjoom, White Plains, NY (US); Debanjan Saha, Mohegan Lake, NY (US); Sambit Sahu, Hopewell Junction, NY (US); Shu Tao, White Plains, NY (US)

Correspondence Address: F. CHAU & ASSOCIATES, LLC, 130 WOODBURY ROAD, WOODBURY, NY, 11797, US

(21) Appl. No.: 11/844,012

(22) Filed: Aug. 23, 2007

(51) Int. Cl. G06F 11/00

(52) U.S. Cl. 714/26; 714/E11.001

(57) ABSTRACT

A system for problem resolution in network and systems management includes a database of trouble ticket data including information fields for checked components and affected components, an automated model builder system that processes the trouble ticket data to construct a causality model to represent causality information between system components identified in the checked component and affected component fields of the trouble ticket data, and an automated problem analysis system that receives information indicative of a problem event and determines a cause of the problem event using the causality model.

### BACKGROUND OF THE INVENTION

1. Technical Field

The present disclosure relates to management of computer networks and systems and, more particularly, to a method and apparatus for efficient problem resolution via an incrementally constructed causality model based on history data.

2. Discussion of Related Art

A computer network includes a number of network devices such as switches, routers and firewalls that are interconnected for the purpose of data communication among the devices and endstations such as mainframes, servers, hosts, printers, fax machines, and others. In computer networks and systems, ensuring correct coordination and interaction between different components is the key to maintaining processes running as services and the main goal of network and systems management.

Network and systems management services employ a variety of tools, applications and devices to assist administrators in monitoring and maintaining networks and systems. Network and systems management can be conceptualized as consisting of five functional areas: configuration management, performance and accountant management, problem management, operations management and change management.

Problem management involves five main steps: problem determination, problem diagnosis, problem bypass and recovery, problem resolution and problem tracking and control. Problem determination consists of detecting a problem and completing other precursory steps to problem diagnosis, such as isolating the problem to a particular subsystem. Problem diagnosis consists of efforts to determine the precise cause of the problem and the action(s) required to solve it. Problem bypass and recovery consists of attempts to partially or completely bypass the problem. The problem resolution step consists of efforts to eliminate the problem. Problem resolution usually begins after problem diagnosis is complete and often involves corrective action, such as the replacement of failed hardware or software.

Problem tracking and control (referred to herein as “trouble ticket” tracking) consists of tracking each problem until final resolution is reached. Information describing the problem may be used to populate a trouble ticket. Methods of automatically generating trouble tickets for network elements that are in failure and affecting network performance are known. Each ticket may combine structured and unstructured data. The structured portion may come from internal information systems, for example, and the unstructured portion may be entered by an operator who receives information over the telephone or via e-mail from a person reporting a problem or a technician fixing the problem. Trouble ticket data may be recorded in a problem database.

Trouble ticket tracking is a vital network/systems management function. The steady growth in size and complexity of networks/systems has necessitated increased efficiency in trouble ticket resolution. A small group of experts often have to handle a large number of tickets. The process usually entails manually searching through the tickets for the possible causes of problems. Some organizations employ a trouble ticket system (also called an issue tracking system or incident ticket system), which is a computer software package that manages and maintains lists of issues, as needed by an organization.

In many cases, network or systems components are functionally dependent on each other. For example, if a router fails to function, its attached servers or other devices may also become inaccessible. Due to the dependencies between various devices and applications, a significant portion of the trouble tickets issued may be correlated or redundant, i.e., multiple tickets can be triggered by a same problem event. When these redundant tickets are issued, multiple operation teams may work toward resolving the same problem, which causes inefficiency in the problem management process. There is a need for methods and apparatus for automatically detecting problem event correlations and, more importantly, correctly identifying the root cause of a problem.

An approach to the event correlation task is to generate a dependency graph to represent the relationship between network elements. A dependency graph can be used to explore the correlations between different network events. For example, a network topology can be represented in a dependency graph to capture the connectivity between various network elements. However, obtaining the full knowledge of this dependency graph is not a simple task, particularly in the case of large-scale networks and systems.

In conventional approaches, it can be difficult to keep the topology and configuration information up-to-date and to make it available to the problem management team. In some cases, the people who manage the network/system only have an incomplete view of the managed network/system, such as when information technology (IT) infrastructure is outsourced. In these cases, the traditional event-correlation method based on complete dependency graph becomes infeasible. A need exists for design approaches that can perform trouble ticket correlation and filtering based on partial knowledge of the managed infrastructure.

### SUMMARY OF THE INVENTION

According to an exemplary embodiment of the present invention, a system for problem resolution in network and systems management includes a database of trouble ticket data including information fields for checked components and affected components, an automated model builder system that processes the trouble ticket data to construct a causality model to represent causality information between system components identified in the checked component and affected component fields of the trouble ticket data, and an automated problem analysis system that receives information indicative of a problem event and determines a cause of the problem event using the causality model.

According to an exemplary embodiment of the present invention, a method for automated problem resolution in network and systems management includes the steps of obtaining trouble ticket data, wherein the trouble ticket data includes information fields for checked components and affected components, processing the trouble ticket data to construct a causality model to represent causality information between system components identified in the checked component and affected component fields of the trouble ticket data, receiving information indicative of a problem event, and determining a cause of the problem event using the causality model.

The present invention will become readily apparent to those of ordinary skill in the art when descriptions of exemplary embodiments thereof are read with reference to the accompanying drawings.

### BRIEF DESCRIPTION OF THE DRAWINGS

FIG. 1 depicts a pictorial representation of a network data processing system, which may be used to implement an exemplary embodiment of the present invention.

FIG. 2 is a block diagram of a data processing system, which may be used to implement an exemplary embodiment of the present invention.

FIG. 3 depicts an example of a data structure representing a causality model, according to an exemplary embodiment of the present invention.

FIG. 4 depicts an example of a data structure representing a causality model, according to an exemplary embodiment of the present invention.

FIG. 5 is a block diagram of system for problem resolution in network and systems management, according to an exemplary embodiment of the present invention.

FIG. 6 depicts an example of a trouble ticket, according to exemplary embodiments of the present invention.

FIG. 7 is a flowchart illustrating a method for automated problem resolution in network and systems management, according to an exemplary embodiment of the present invention.

### DESCRIPTION OF EXEMPLARY EMBODIMENTS

Hereinafter, exemplary embodiments of the present invention will be described with reference to the accompanying drawings. As used herein, the term “causality graph” refers to a dependency graph in which nodes represent the system components and directed edges represent causality relationships between the nodes.

It is to be understood that exemplary embodiments of the present invention described herein may be implemented in various forms of hardware, software, firmware, special purpose processors, or a combination thereof. An exemplary embodiment of the present invention may take the form of an entirely hardware embodiment, an entirely software embodiment or an embodiment containing both hardware and software elements. An exemplary embodiment may be implemented in software as an application program tangibly embodied on one or more program storage devices, such as for example, computer hard disk drives, CD-ROM (compact disk-read only memory) drives and removable media such as CDs, DVDs (digital versatile discs or digital video discs), Universal Serial Bus (USB) drives, floppy disks, diskettes and tapes, readable by a machine capable of executing the program of instructions, such as a computer. The application program may be uploaded to, and executed by, an instruction execution system, apparatus or device comprising any suitable architecture. It is to be further understood that since exemplary embodiments of the present invention depicted in the accompanying drawing figures may be implemented in software, the actual connections between the system components (or the flow of the process steps) may differ depending upon the manner in which the application is programmed.

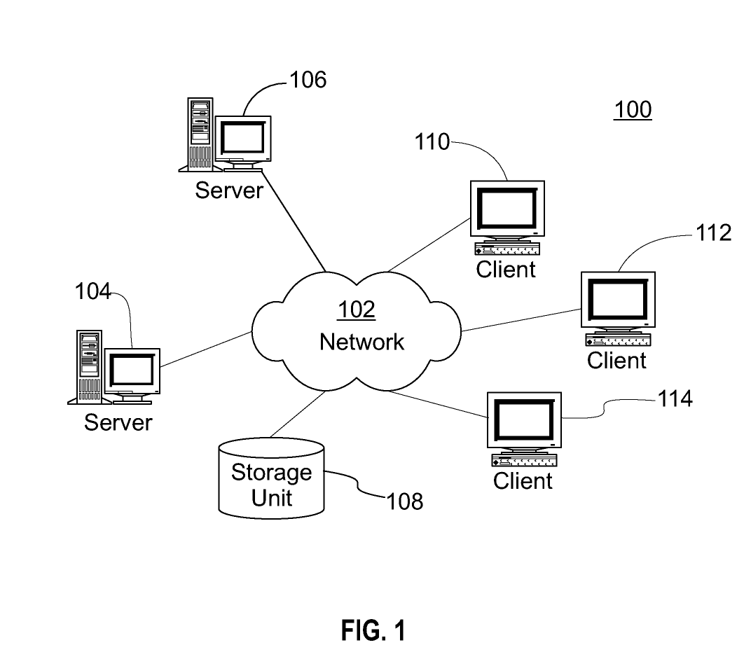

FIG. 1 depicts a pictorial representation of a network data processing system, which may be used to implement an exemplary embodiment of the present invention. Network data processing system 100 includes a network of computers, which can be implemented using any suitable computers. Network data processing system 100 may include, for example, a personal computer, workstation or mainframe. Network data processing system 100 may employ a client-server network architecture in which each computer or process on the network is either a client or a server.

Network data processing system 100 includes a network 102, which is a medium used to provide communications links between various devices and computers within network data processing system 100. Network 102 may include a variety of connections such as wires, wireless communication links, fiber optic cables, connections made through telephone and/or other communication links.

A variety of servers, clients and other devices may connect to network 102. For example, a server 104 and a server 106 may be connected to network 102, along with a storage unit 108 and clients 110, 112 and 114, as shown in FIG. 1. Storage unit 108 may include various types of storage media, such as for example, computer hard disk drives, CD-ROM drives and/or removable media such as CDs, DVDs, USB drives, floppy disks, diskettes and/or tapes. Clients 110, 112 and 114 may be, for example, personal computers and/or network computers.

Client 110 may be a personal computer. Client 110 may comprise a system unit that includes a processing unit and a memory device, a video display terminal, a keyboard, storage devices, such as floppy drives and other types of permanent or removable storage media, and a pointing device such as a mouse. Additional input devices may be included with client 110, such as for example, a joystick, touchpad, touchscreen, trackball, microphone, and the like.

Clients 110, 112 and 114 may be clients to server 104, for example. Server 104 may provide data, such as boot files, operating system images, and applications to clients 110, 112 and 114. Network data processing system 100 may include other devices not shown.

Network data processing system 100 may comprise the Internet with network 102 representing a worldwide collection of networks and gateways that use the Transmission Control Protocol/Internet Protocol (TCP/IP) suite of protocols to communicate with one another. The Internet includes a backbone of high-speed data communication lines between major nodes or host computers consisting of a multitude of commercial, governmental, educational and other computer systems that route data and messages.

Network data processing system 100 may be implemented as any suitable type of networks, such as for example, an intranet, a local area network (LAN) and/or a wide area network (WAN). The pictorial representation of network data processing elements in FIG. 1 is intended as an example, and not as an architectural limitation for embodiments of the present invention.

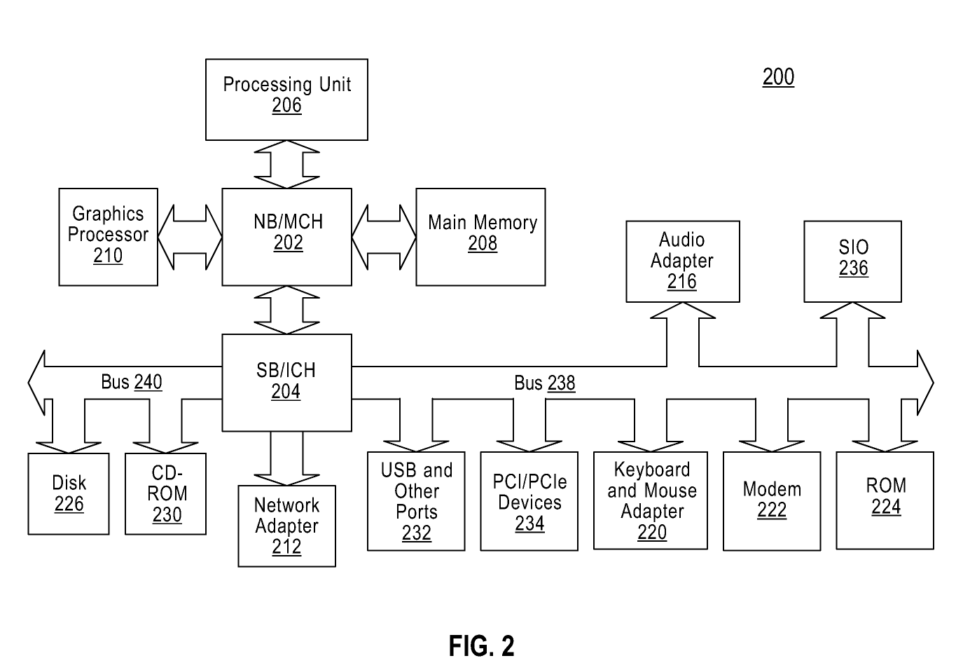

FIG. 2 is a block diagram of a data processing system, which may be used to implement an exemplary embodiment of the present invention. Data processing system 200 is an example of a computer, such as server 104 or client 110 of FIG. 1, in which computer usable code or instructions implementing processes of embodiments of the present invention may be located.

In the depicted example, data processing system 200 employs a hub architecture including a north bridge and memory controller hub (NB/MCH) 202 and a south bridge and input/output (I/O) controller hub (SB/ICH) 204. Processing unit 206 that includes one or more processors, main memory 208, and graphics processor 210 are coupled to the north bridge and memory controller hub 202. Graphics processor 210 may be coupled to the NB/MCH 202 through an accelerated graphics port (AGP). Data processing system 200 may be, for example, a symmetric multiprocessor (SMP) system including a plurality of processors in processing unit 206. Data processing system 200 may be a single processor system.

In the depicted example, local area network (LAN) adapter 212 is coupled to south bridge and I/O controller hub 204. Audio adapter 216, keyboard and mouse adapter 220, modem 222, read only memory (ROM) 224, universal serial bus (USB) ports and other communications ports 232, and PCI/PCIe (PCI Express) devices 234 are coupled to south bridge and I/O controller hub 204 through bus 238, and hard disk drive (HDD) 226 and CD-ROM drive 230 are coupled to south bridge and I/O controller hub 204 through bus 240.

Examples of PCI/PCIe devices include Ethernet adapters, add-in cards, and PC cards for notebook computers. In general, PCI uses a card bus controller while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be coupled to south bridge and I/O controller hub 204.

An operating system, which may run on processing unit 206, coordinates and provides control of various components within data processing system 200. For example, the operating system may be a commercially available operating system such as Microsoft® Windows® XP (Microsoft and Windows are trademarks or registered trademarks of Microsoft Corporation in the United States, other countries, or both). An object-oriented programming system, such as the Java™ programming system, may run in conjunction with the operating system and provides calls to the operating system from Java programs or applications executing on data processing system 200 (Java and all Java-based marks are trademarks or registered trademarks of Sun Microsystems, Inc. in the United States, other countries, or both).

Instructions for the operating system, object-oriented programming system, applications and/or programs of instructions are located on storage devices, such as for example, hard disk drive 226, and may be loaded into main memory 208 for execution by processing unit 206. Processes of exemplary embodiments of the present invention may be performed by processing unit 206 using computer usable program code, which may be located in a memory, such as for example, main memory 208, read only memory 224 or in one or more peripheral devices.

It will be appreciated that the hardware depicted in FIGS. 1 and 2 may vary depending on the implementation. Other internal hardware or peripheral devices, such as flash memory, equivalent non-volatile memory, or optical disk drives and the like, may be used in addition to or in place of the depicted hardware. Processes of embodiments of the present invention may be applied to a multiprocessor data processing system.

Data processing system 200 may take various forms. For example, data processing system 200 may be a tablet computer, laptop computer, or telephone device. Data processing system 200 may be, for example, a personal digital assistant (PDA), which may be configured with flash memory to provide non-volatile memory for storing operating system files and/or user-generated data. A bus system within data processing system 200 may include one or more buses, such as a system bus, an I/O bus and PCI bus. It is to be understood that the bus system may be implemented using any type of communications fabric or architecture that provides for a transfer of data between different components or devices coupled to the fabric or architecture. A communications unit may include one or more devices used to transmit and receive data, such as modem 222 or network adapter 212. A memory may be, for example, main memory 208, ROM 224 or a cache such as found in north bridge and memory controller hub 202. A processing unit 206 may include one or more processors or CPUs.

Methods for automated problem resolution in network and systems management according to exemplary embodiments of the present invention may be performed in a data processing system such as data processing system 100 shown in FIG. 1 or data processing system 200 shown in FIG. 2.

It is to be understood that a program storage device can be any medium that can contain, store, communicate, propagate or transport a program of instructions for use by or in connection with an instruction execution system, apparatus or device. The medium can be, for example, an electronic, magnetic, optical, electromagnetic, infrared, or semiconductor system (or apparatus or device) or a propagation medium. Examples of a program storage device include a semiconductor or solid state memory, magnetic tape, removable computer diskettes, RAM (random access memory), ROM (read-only memory), rigid magnetic disks, and optical disks such as a CD-ROM, CD-R/W and DVD.

A data processing system suitable for storing and/or executing a program of instructions may include one or more processors coupled directly or indirectly to memory elements through a system bus. The memory elements can include local memory employed during actual execution of the program code, bulk storage, and cache memories that provide temporary storage of at least some program code to reduce the number of times code must be retrieved from bulk storage during execution.

Data processing system 200 may include input/output (I/O) devices, such as for example, keyboards, displays and pointing devices, which can be coupled to the system either directly or through intervening I/O controllers. Network adapters may also be coupled to the system to enable the data processing system to become coupled to other data processing systems or remote printers or storage devices through intervening private or public networks. Network adapters include, but are not limited to, modems, cable modem and Ethernet cards.

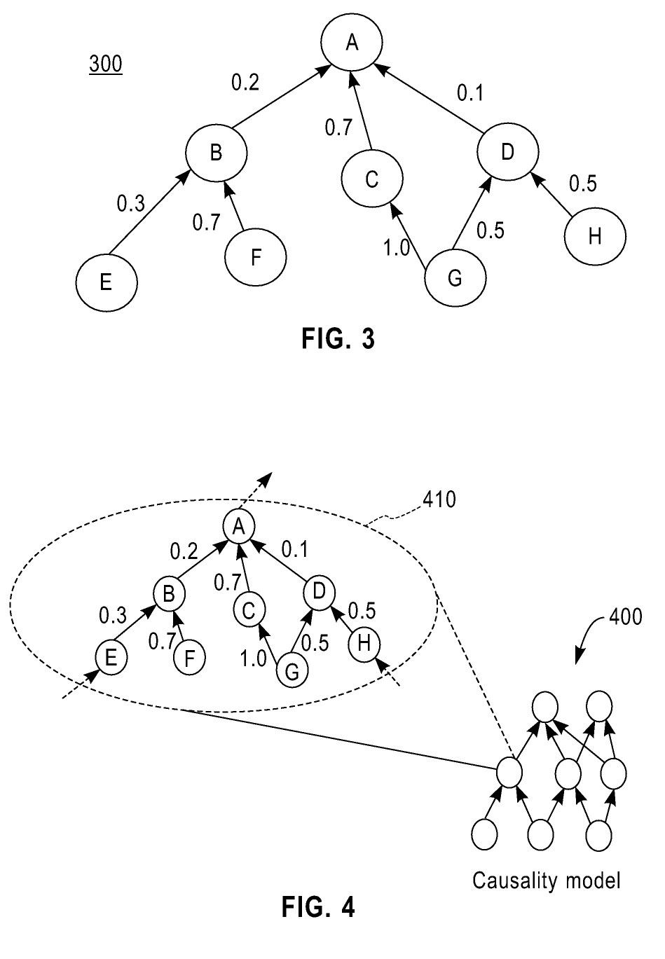

FIG. 3 depicts an example of a data structure representing a causality model, according to an exemplary embodiment of the present invention. Referring to FIG. 3, the data structure 300 is a directed graph with weighted edges. The data structure 300 may be, for example, a dependency graph containing resource dependency characteristics of the sample application. A dependency graph may be expressed as an XML file that highlights the relationships and dependencies between different components. The data structure 300 may be a causality graph in which nodes A though H represent the system components and directed edges represent causality relationships between the nodes. However, it is to be understood that any suitable logical data structure may be employed.

FIG. 4 depicts an example of a data structure representing a causality model, according to an exemplary embodiment of the present invention. Referring to FIG. 4, the example data structure 400 is a dependency graph. The dependency graph 400 captures the functional dependency between managed components. However, the constructed dependency graph 400 may not contain the dependency between all components. The expanded view of node 410 shows the dependency graph 300 of FIG. 3. In this example, nodes A though H represent subsystem components of the node 410. That is, the dependency graph 400 can simply represent network topology, or it can further capture the dependency between the subsystems (e.g., interfaces, processes, etc) of all devices.

In an exemplary embodiment of the present invention, a causality model includes sub-models, wherein the sub-models are causality graphs in which nodes/sub-nodes represent the system/subsystem components and directed edges represent causality relationships between the nodes/sub-nodes.

In the trouble ticket resolving process, an administrator may check the availability or performance of certain network elements to identify the root cause of the problem or failure (referred to herein as a “problem event”). In an exemplary embodiment of the present invention, the knowledge accumulated in the ticket resolving process is used to infer and construct/update the dependency graph of the managed network system. Once the dependency graph is correctly inferred, it can be used to filter and consolidate the redundant tickets that are generated by the same root cause, identify the root cause of the problem, and/or formulate the steps that a network operator should follow to solve the problem reported in the consolidated tickets.

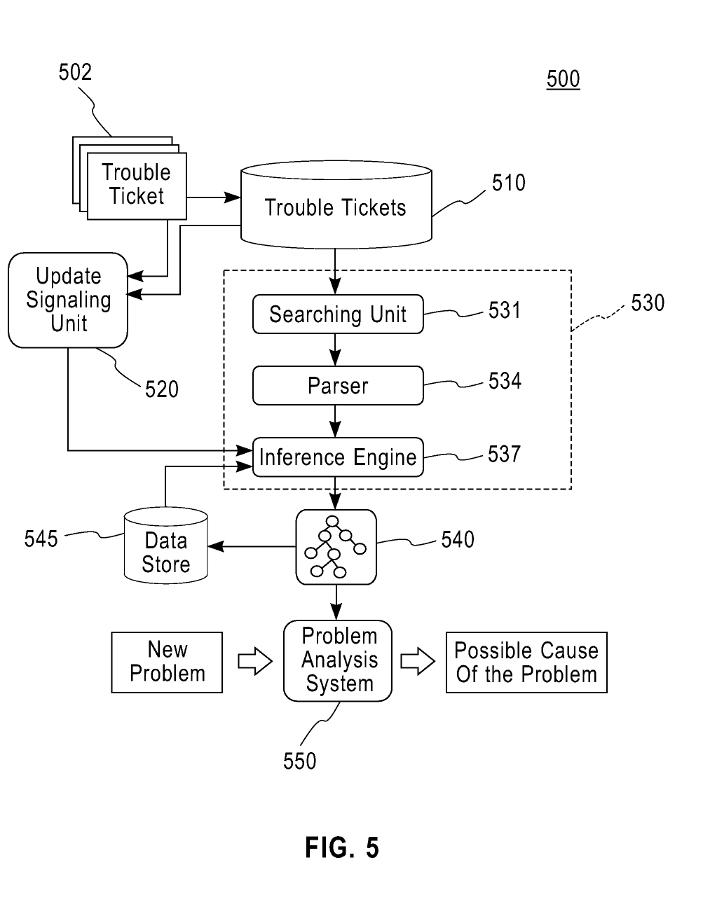

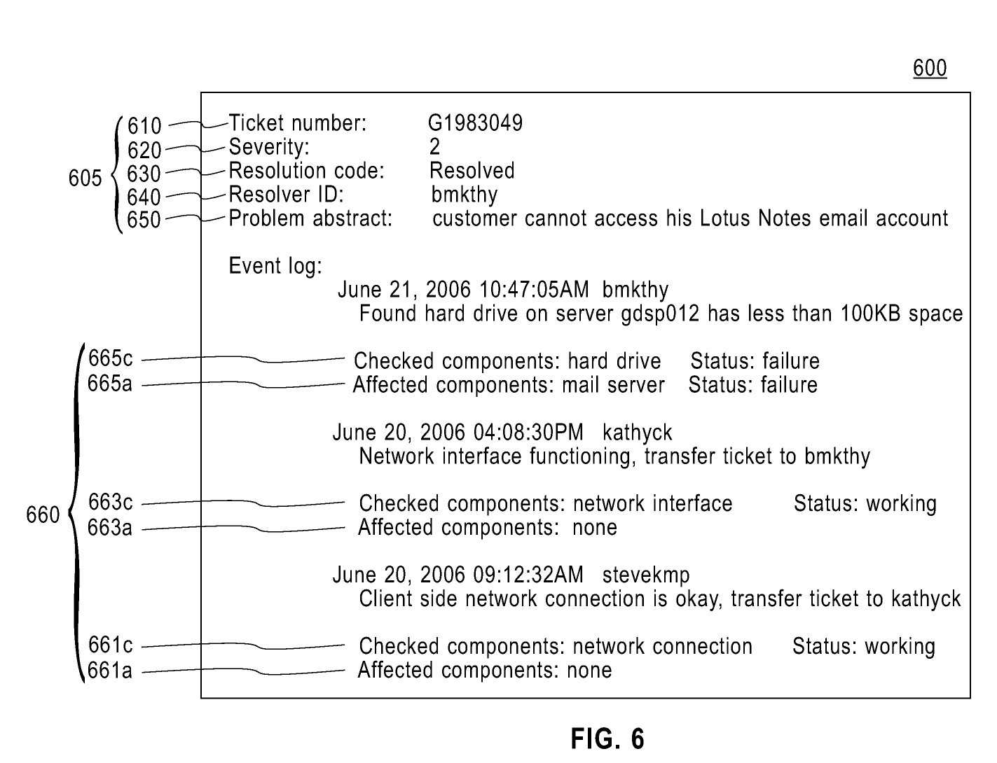

FIG. 5 is a block diagram of system for problem resolution in network and systems management, according to an exemplary embodiment of the present invention. FIG. 6 depicts an example of a trouble ticket, according to an exemplary embodiment of the present invention.

Referring to FIG. 5, the system for problem resolution in network and systems management 500 includes a database of trouble ticket data 510, which may include information fields for checked components and affected components, an automated model builder system 530, and an automated problem analysis system 550.

The automated model builder system 530, according to an exemplary embodiment of the present invention, processes the trouble ticket data 510 to construct a causality model 540 to represent causality information between system components identified in checked component and affected component fields of the trouble ticket data 510. The causality model 540 may be, for example, a causality graph in which nodes represent the system components and directed edges represent causality relationships between the nodes.

The automated model builder system may assign weights to the directed edges, wherein each weight represents a likelihood that a first problem that occurred to a first component can be a cause of a second problem that occurred to a second component. The edge weights in the dependency graph may be updated after receiving each trouble ticket according to the following method.

1. parse the problem record
2. identify the failed network element y in the ticket
3. identify the network elements [xᵢ] tested in the ticket resolution
process
4. for each xᵢ
5. if xᵢ failed in the same time during which y failed
6. if fixing xᵢ resolved the problem for y
7. increase the weight of (xᵢ,y) by S(t),

where S(t) and s(t) are a function of time t. Typically, the value of S(t) decays over time, so that the history observations have an impact on the constructed dependency graph only for a limited period time. For example, S(t) may be expressed as S(t)=e^{t} if t<T, S(t)=0 if t≧T.

The edge weights in the dependency graph may be updated according to the following method.

1. parse the problem record
2. identify the main component y that had the problem
3. identify a set of components [xᵢ] that were found to be the cause
4. identify a set of components [zᵢ] that were affected by the
problem of y
5. for each xᵢ
6. if edge (xᵢ,y) does not exit
7. add edge (xᵢ,y) and assign weight d(t)
8. else
9. increase the weight of edge(xᵢ,y) by d(t)
10. normalize the weight of all edge to y
11. for each zᵢ
12. if edge (y,zᵢ) does not exist
13. add edge (y,zᵢ) and assign weight d(t)
14. else
15. increase the weight of edge (y,zᵢ) by d(t)
16. normalize the weight of all edges to zᵢ

This method may be run every time a trouble ticket is received. When d(t) is assigned or added to the weight of an edge, a clock starts running, and d(t) is a function of the time represented by this clock. The clock ensures that the value of d(t) decays over time. For example, d(t) may be expressed as d(t)=Ds^{t} if t<T, d(t)=0 if t≧T, where 0<s<1. For example, d(t) gets updated after each tick of its clock.

Referring to FIG. 6, the example trouble ticket 600 has a structured format and includes a header portion 605 and an event log 660. The header portion 605 includes entry fields for ticket number 610, severity rating 620 (e.g., a scale of 1 to 5, where 1=minor and 5=critical), resolution code 630 (e.g., “resolved”, “pending”, “onhold”), resolver ID 640 (e.g., “bmkthy”), and problem abstract 650. The event log 660 includes date and time stamps and corresponding information fields for checked components 661c, 663c and 661c and affected components 661a, 663a and 661a, and their corresponding status fields.

Trouble tickets may contain troubleshooting history information that reflects the dependency between the tested network elements and the failed ones. A trouble ticket may contain structured information about the problem determination process. It will be appreciated that trouble tickets may combine structured and unstructured data in various formats. Trouble ticket data may be stored in a database.

In an exemplary embodiment of the present invention, the automated model builder system 530 includes a searching unit 531 to search for predetermined keywords in the trouble ticket data and a parser 534 to automatically parse the trouble ticket data 510 into data parts, such as for example, checked components and affected components.

The automated model builder system 530 may include an inference engine 537 that analyzes the data parts to identify a main component, a set of cause components and a set of affected components. For example, based on the impact of a tested network element on the failed component (e.g., whether the trouble shooting activities related to the tested network element has impact on the failed component, or whether the tested network element itself is affected by the failed components, etc.), the inference engine 537 may infer the relation between the tested network elements and the failed component to construct the causality graph 540. A data store 545 may be provided for storing the causality graph 540.

The automated problem analysis system 550 receives information indicative of a problem event and determines a possible cause of the problem event using the causality model 540. Description of the problem event may be provided in a trouble ticket. For example, the problem abstract 650 of the example trouble ticket 600 reads: “customer cannot access his Lotus Notes email account”.

In an exemplary embodiment of the present invention, the automated problem analysis system 550 uses the weights assigned to the directed edges of the causality graph 540 to determine the cause of the problem event. For example, in a scenario using the causality graph 300, where component A failed, the automated problem analysis system 550 may infer that, with 70% likelihood, component C is the cause of the problem. Accordingly, component C can be tested to determine if that is indeed the case. If it is determined that the component C is not the cause of the problem, then the automated problem analysis system 550 may infer that component B, with 20% likelihood, is the cause of the problem, and so on. Thus, using the causality graph 300, the root cause of the failure of component A can be correctly identified.

The system for problem resolution in network and systems management 500 may include an automated update signaling unit 520. The automated update signaling unit 520 may process new trouble ticket data 502 to determine whether an update to the causality graph 540 stored in the data store 545 is required and, if an update is determined to be required, transmits a signal to the automated model builder system 530 to construct an updated causality graph.

For example, the automated update signaling unit 520 may determine whether an update to the causality graph 540 is required based on information in a checked component field, an affected component field and/or other field of the new trouble ticket data 502. In an exemplary embodiment of the present invention, responsive to the signal from the automated update signaling unit 520, the automated model builder 530 obtains the causality graph 540 from the data store, constructs an updated causality graph using the new trouble ticket data 502 and stores the updated causality graph in the data store 545.

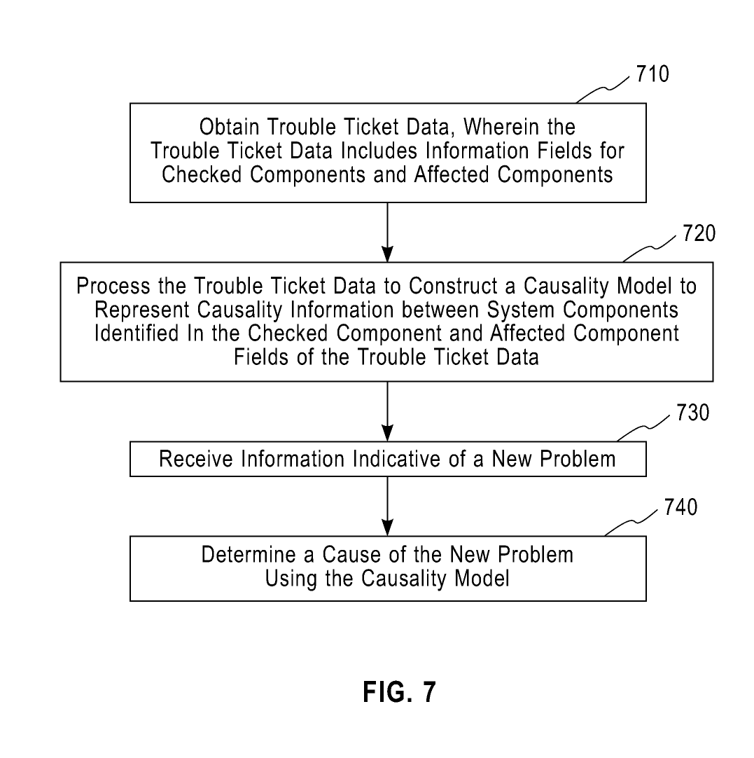

FIG. 7 is a flowchart illustrating a method for automated problem resolution in network and systems management, according to an exemplary embodiment of the present invention. Referring to FIG. 7, in step 710, trouble ticket data is obtained. Trouble ticket data may include a plurality of information fields, such as for example, checked components and affected components.

In step 720, the trouble ticket data is processed to construct a causality model to represent causality information between system components identified in the checked component and affected component fields of the trouble ticket data. The causality model may be, for example, a causality graph in which nodes represent the system components and directed edges represent causality relationships between the nodes. Weights may be assigned to the directed edges, wherein each weight may represent a likelihood that a first problem that occurred to a first component can be a cause of a second problem that occurred to a second component.

In an exemplary embodiment of the present invention, processing the trouble ticket data includes parsing the trouble ticket data into data parts, including checked components and affected components, and analyzing the data parts to identify a main component, a set of cause components and a set of affected components.

In step 730, information indicative of a problem event is received. In step 740, a possible cause of the problem event is determined using the causality model. One possible form of implementation of step 740 is the generation of a list of components that could potentially have caused the problem, each annotated with the likelihood of root cause, based on a derived causality graph.

Although exemplary embodiments of the present invention have been described in detail with reference to the accompanying drawings for the purpose of illustration and description, it is to be understood that the inventive processes and apparatus are not to be construed as limited thereby. It will be apparent to those of ordinary skill in the art that various modifications to the foregoing exemplary embodiments may be made without departing from the scope of the invention as defined by the appended claims, with equivalents of the claims to be included therein.

1. A system for problem resolution in network and systems management, comprising:
a database of trouble ticket data including information fields for checked components and affected components;
an automated model builder system that processes the trouble ticket data to construct a causality model to represent causality information between system components identified in the checked component and affected component fields of the trouble ticket data,
wherein the causality model is a causality graph in which nodes represent the system components and directed edges represent causality relationships between the nodes, and wherein the automated model builder system assigns weights to the directed edges, wherein each weight represents a likelihood that a first problem that occurred to a first component can be a cause of a second problem that occurred to a second component; and
an automated problem analysis system that receives information indicative of a problem event and determines a cause of the problem event using the causality model.

2-3. (canceled)

4. The system of claim 1, wherein the automated model builder system includes a searching unit to search for predetermined keywords in the trouble ticket data and a parser to automatically parse the trouble ticket data into data parts including checked components and affected components.

5. The system of claim 4, wherein the automated model builder system further includes an inference engine that analyzes the data parts to identify a main component, a set of cause components and a set of affected components.

6. The system of claim 1, wherein the automated problem analysis system uses the weights assigned to the directed edges of the causality graph to determine the cause of the problem event.

7. The system of claim 1, further comprising a data store for storing the causality graph.

8. The system of claim 7, further comprising an automated update signaling unit that processes new trouble ticket data to determine whether an update to the causality graph stored in the data store is required and, if an update is determined to be required, transmits a signal to the automated model builder system to construct an updated causality graph.

9. The system of claim 8, wherein the automated update signaling unit determines whether an update to the causality graph is required based on the presence of information in a checked component or affected component field of the new trouble ticket data.

10. The system of claim 8, wherein responsive to the signal from the automated update signaling unit, the automated model builder obtains the causality graph from the data store, constructs an updated causality graph using the new trouble ticket data and stores the updated causality graph in the data store.

11. A method for automated problem resolution in network and systems management, comprising:
obtaining trouble ticket data, wherein the trouble ticket data includes information fields for checked components and affected components;
processing the trouble ticket data to construct a causality model to represent causality information between system components identified in the checked component and affected component fields of the trouble ticket data,
wherein the causality model is a causality graph in which nodes represent the system components and directed edges represent causality relationships between the nodes, and wherein weights are assigned to the directed edges, and wherein each weight represents a likelihood that a first problem that occurred to a first component can be a cause of a second problem that occurred to a second component;
receiving information indicative of the second problem; and
determining the first problem to be a cause of the problem event using the causality model, wherein a weight assigned to an edge between a node of the first component and a node of the second component is increased upon determining the first problem to be the cause of the second problem and decays over time.

12. The method of claim 11, wherein processing the trouble ticket data comprises:
parsing the trouble ticket data into data parts including checked components and affected components; and
analyzing the data parts to identify a main component, a set of cause components and a set of affected components.

13-14. (canceled)

15. A program storage device readable by a machine, tangibly embodying a program of instructions executable by the machine to perform method steps for automated problem resolution in network and systems management, the method steps comprising:
obtaining trouble ticket data, wherein the trouble ticket data includes information fields for checked components and affected components;
processing the trouble ticket data to construct a causality model to represent causality information between system components identified in the checked component and affected component fields of the trouble ticket data,
wherein the causality model is a causality graph in which nodes represent the system components and directed edges represent causality relationships between the nodes and wherein weights are assigned to the directed edges, and wherein each weight represents a likelihood that a first problem that occurred to a first component can be a cause of a second problem that occurred to a second component;
receiving information indicative of the second problem; and
determining the first problem to be a cause of the problem event using the causality model, wherein a weight assigned to an edge between a node of the first component and a node of the second component is increased upon determining the first problem to be the cause of the second problem and decays over time.

16-17. (canceled)

18. The program storage device of claim 15, wherein processing the trouble ticket data comprises:
parsing the trouble ticket data into data parts including checked components and affected components; and
analyzing the data parts to identify a main component, a set of cause components and a set of affected components.
